(19) United States
(12) Patent Application Publication
(10) Pub. No.: US 2004/0243421 A1
(43) Pub. Date: Dec. 2, 2004

(54) System and method of presenting construction specifications

(76) Inventors: Frederick P. Jannott, Westport, CT (US); William Jannott, Highland Mills, NY (US)

Correspondence Address: ST. ONGE STEWARD JOHNSTON & REENS, LLC, 986 BEDFORD STREET, STAMFORD, CT, 06905-5619, US

(21) Appl. No.: 10/448,857

(22) Filed: May 29, 2003

(51) Int. Cl. G06F 17/60

(52) U.S. Cl. 705/1

(57) ABSTRACT

A system for generating a construction specifications file from a predetermined list of construction specifications is provided. The system is responsive to a user selection. The system includes a host operatively in communication with a computer; and a database manipulated by the host. The database includes at least one construction product file associated with a construction product, a user selection, an indication, a product choice, a first product file, and a list of construction specifications. The system further includes an indication specific to the construction product; a first abstract layer for generating a query environment responsive to at least one instruction data block, where the first abstract layer executes cooperatively with a second abstract layer on the computer; and a first product file for populating the query environment. The first product file includes at least one instruction data block and at least one second data block. The system further includes a user selection associated with the construction product choice, where the user selection is generated by the interactive menu upon input by a user, the user selection received by the host; and a construction specifications file generated by the host by manipulating the list of construction specifications responsive to the user selection.

### FIELD OF THE INVENTION

The present invention relates to a system and method of presenting construction specification to a user upon user input and methods of promoting clients to a receptive audience by presenting one or more construction specifications to a user upon user input.

### BACKGROUND OF THE INVENTION

Successful commercial construction of facilities, such as office buildings, residences, water systems, transportation facilities, is a complex interplay among engineers, architects, contractors, suppliers, manufacturers, and facility owners. Typically all parties rely to a critical extent on at least two contract documents used in construction—plans and specifications. For simplicity “plans” and “specifications” will be used throughout and may express the singular as well as the plural.

Plans convey primarily technical details of the facility through engineering drawings that depict the facility layout and through more detailed construction drawings that utilize symbols to explain construction features. However, because of their focus on the visual aspects, plans are limited in conveying descriptive information and to calling out features and items, i.e. “concrete,” “4 inch diameter pipe,” etc., without significant appended description.

Specifications convey further descriptive information by specifying processes, materials, and conditions for features. Some features such as columns, walls, and footings are normally built on-site. Other features such as doors, windows, railings, etc. may be produced off-site and shipped to the facility site. Contractors implement specifications for such items by either custom crafting them or seeking appropriate commercially available products from suppliers and manufacturers that match the specifications.

Some specifications that are essentially fungible have been standardized by industry trade groups. In contrast, items that are not fungible generally do not lend themselves to complete standardization. While a door, for example, comes in standard dimensions, i.e. single width or double width, that are easily represented on plans; the door also contains elements of style and taste. Is the door to be plain or paneled; painted or stained; made of oak or oak veneer; made of natural or artificial material? Is the locking mechanism to be brass, steel, or copper; keyed or unkeyed? Is there to be a doorknob, door handle, or slide? Each option is a decision that an architect and facility owner must carefully consider and specify in the contract documents.

In practice, it is rare that architects specify custom products because of vastly increased labor and production costs due to customization. Thus, architects consult manufacturers' and suppliers' catalogs to present appropriate products to their clients. Although a manufacturer may require drawings to make the requisite product, architects and engineers find it easiest to represent selected commercially available products using generic symbols in the plans and describe relevant processes, materials, and conditions more specifically in text form as specifications.

Towards that end, manufacturers and suppliers go to great lengths to make listings of their products known to professionals in the construction industry. Typically, manufacturers and suppliers print glossy photo-rich product catalogs complete with sample specifications. Further product dissemination occurs as trade groups and industry publishers prepare compilations of the product catalogs of many manufacturers and suppliers into periodically updated topical catalogs, i.e. one volume dedicated to windows and doors, another to piping, etc., that are available on a subscription basis.

While local practice varies, a typical specification for a fire-escape ladder in a larger specification document, often called a bid document, is illustrated in FIG. 2. Specifications commonly follow the three part description text formatting illustrated. Each “part” is subdivided into further topical sections which aggregate statements about the products. The relative location of this specification to other specifications is indicated by a section number, shown at label A. At label B, technical details of loading capacity, rise and tread, and safety requirements are provided. Since construction elements interrelate to other elements, for example at labels C, other sections are commonly referenced.

Architects and engineers use the sample specifications provided in the catalogs to draft their own specifications for inclusion in the contract documents. However, as product lines and the number of available style options increase, the chance for errors in specifications compound as the product may be available in certain styles only in combination with other styles. One method to reduce potential errors is to provide a template specification. The template includes one or more blanks. Instructions point users to specific areas of the catalog to complete the blanks. This method itself has several drawbacks. The main drawback is that specifications and the blank template are essentially collections of statements that relate to a product. To fill in a blank template specification an architect or engineer must “solve” the template much as one would solve a puzzle, one statement at a time. Afterwards, the completed specification must be painstakingly rechecked to fully evaluate that all statements are correctly related to the product and interrelated to other specifications. Doing so, the user has to solve the puzzle in a manner non-analogous to his thought process-whereas, architects think of a commercially available product as whole applications that they wish to add within the context of the facility design, they must rummage through all facets of the product specification in order to assure correctness.

Electronic availability of product catalogs from manufacturers and suppliers through web sites eases time and cost barriers inherent to publishing the same catalogs. However, to overcome the aforementioned drawback, each possible variant of a specification must be made a record in an exhaustive database and presented to a user electronically. A drawback to such a system is that a means to access each record must be made available. Including a link to the relevant specification next to the product and creating the specification in an active server page is one way. By contrast, an outline format listing of all products where a user drills down to the desired product is an inconvenient way to access a specification. In an outline, a product having multiple style options may be correctly placed within the outline in multiple locations according to each option. Even when a means is established to access the database, access is made to a complete specification thus requiring a database with an extensive duplication of the same specification.

What is desired, therefore, is method of presenting a construction specification to a user upon user input that overcomes the aforementioned drawbacks.

It is also desired to provide methods of promoting clients to a receptive audience by presenting one or more construction specifications to a user upon user input.

### SUMMARY OF THE INVENTION

Accordingly, it is an object of the present invention to present construction specifications to a user upon user input more efficiently.

Another object of the present invention is to provide a system and method for generating a construction specification based upon user input.

A further object of the present invention is promote a construction product, its manufacturer, and/or its distributor by providing to a user a construction specification.

A further object is to provide construction specifications in an electronic format with a selectable file format.

These and other objects of the present invention are accomplished with a system for generating a construction specifications file from a predetermined list of construction specifications. The system is responsive to a user selection. The system includes a host operatively in communication with a computer; and a database manipulated by the host. The database includes at least one construction product file associated with a construction product, a user selection, an indication, a product choice, a first product file, and a list of construction specifications. The system further includes an indication specific to the construction product where the indication is generated by the computer and received by the host; a first abstract layer for generating a query environment responsive to at least one instruction data block, where the first abstract layer executes cooperatively with a second abstract layer on the computer; and a first product file for populating the query environment.

The first product file includes at least one instruction data block and at least one second data block, where the instruction data block is executable in the abstract layer for generating at least one interactive menu in the query environment, and the second data block is executable in the abstract layer for presenting the construction product choice in the interactive menu. The system further includes a user selection associated with the construction product choice, where the user selection is generated by the interactive menu upon input by a user, the user selection received by the host; and a construction specifications file generated by the host by manipulating the list of construction specifications responsive to the user selection.

A method for generating a construction specifications file is also provided.

### BRIEF DESCRIPTION OF THE DRAWINGS

FIG. 1 is a schematic diagram of a system for generating a construction specifications file in accordance with one embodiment of the invention.

FIG. 2 is a printed sample specification as generated by the system upon user input in accordance with one embodiment of the invention.

FIG. 3. is a schematic of the interaction between a host and a computer in accordance with one embodiment of the invention.

FIG. 4 is a schematic of the interaction between a host and a database in accordance with one embodiment of the invention.

FIG. 5 is a flow diagram depicting the use of a functional software module in accordance with one embodiment of the invention.

FIG. 6 is a depiction of the query environment in accordance with one embodiment of the invention.

FIG. 7 is a depiction of the binary code of a first product file for populating the query environment in accordance with one embodiment of the invention.

### DETAILED DESCRIPTION OF THE DRAWINGS

System 10 is a system for generating one or more construction specification files 500 of a construction product for a user based upon one or more user selections 320 made in an interactive menu 304 presented in a query environment 300. The presentation and generation of construction specification file 500 advantageously promotes the construction product and its manufacturer and/or distributor, herein manufacturer for clarity.

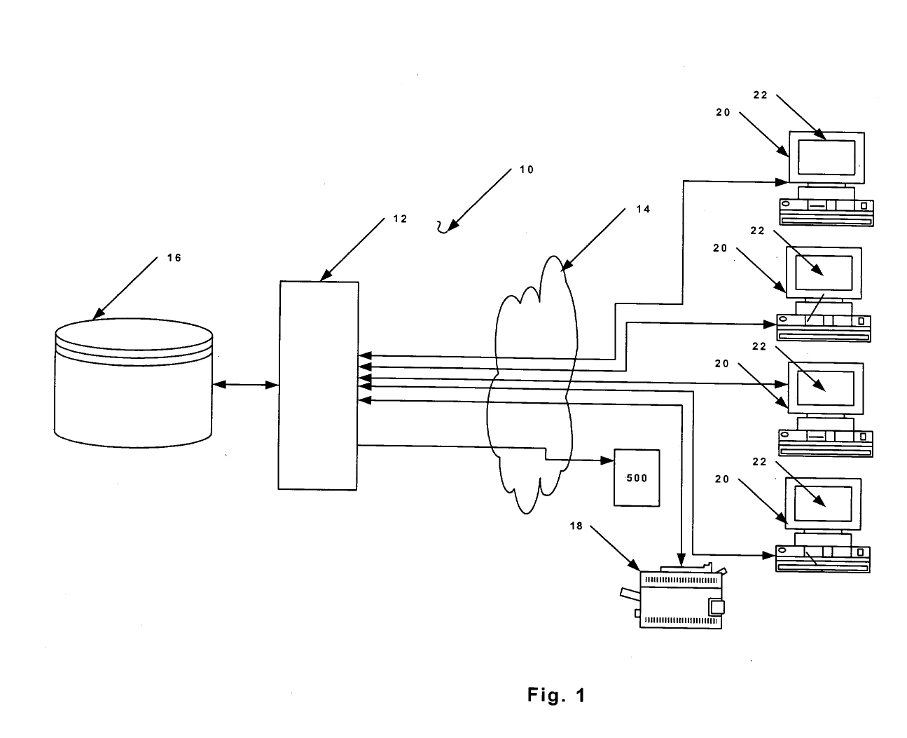

FIG. 1 is a schematic diagram of a system 10 for generating a construction specifications file in accordance with one embodiment of the invention. System 10 includes a host 12 operatively in communication via a communications network 14 with at least one computer 20 used by user 30 during a session. As will be readily understood, as long as the user utilizes one computer during each session, the user may use more than one computer 20 or multiple users may use one computer 20 during different sessions.

Computer 20 may be any kind of computer and/or computing device capable of performing the function described herein. Therein, computer 20 may be a personal computer, a personal digital assistant, and the like and may be operated using any operating system 21 capable of performing the functions described herein, whether already developed or to be developed. For clarity, computer 20 will be described herein with respect to Microsoft Windows®, i.e. Windows 95, Windows 98, Windows NT, Windows Me, etc., or UNIX, i.e. Linux flavors, Lindows, HP UNIX, SCO UNIX, etc. operating systems since these are the most widely used operating systems. Computer 20 includes a display 22 which may be a CRT or LCD monitor, LCD display, any display method, a braille interactive device, a Kurzweil character-to-speech device, and/or the like known or to be developed.

Host 12 may be any kind of computing device capable of performing the functions as described herein. Thus, host 12 may be a personal computer, minicomputer, main frame, supercomputer, web servers, or an aggregation of computers in a distributed computer network, or a combination thereof, and may be physically located anywhere convenient or expeditious or may be located as required by law and/or in compliance with regulatory authority. Further, host 12 may be operated using any operating system capable of performing the functions described herein, whether already developed or to be developed. For clarity, host 12 will be described herein with respect to MicroSoft Windows®, i.e. Windows 95, Windows 98, Windows NT, Windows Me, etc., or UNIX, i.e. Linux flavors, Lindows, HP UNIX, SCO UNIX, etc. operating systems since these are the most widely used operating systems.

Communications network 14 may be any kind of communications network that permits communication between host 12 and a user. Thus, network 14 may be the internet, i.e. the world wide web; a local area network; a wide area network; an intranet; and/or the like capable of performing the functions described herein, whether connected physically or connected through a wireless system and/or whether now known or yet to be developed and/or implemented. For clarity, network 14 is described with respect to the Internet since it is the most widely used communications network. However, the present invention is not limited to the internet.

System 10 further includes at least one database 16 manipulated by host 12. Database 16 may be any database capable of performing the functions described herein. Therein, it is preferred that database 16 is a relational database capable storing a plurality of files. As is readily understood, even when database 16 is limited to a relational database type, it may have a plurality of architectures and is not limited to the architecture described herein; for example where a relational architecture a hierarchical architecture may be used.

System 10 includes equipment 18 that is in communication with host 12 and/or computer 20. Equipment 18 may be any equipment convenient to computer 20 or system 10; thus, equipment 18 may be a laser or ink printer for printing text, a plotter for providing drawings, a media drive such as a CD-ROM or DVD drive, a data storage device such as a hard drive or bio-storage unit, and/or other useful and/or convenient equipment. As will be readily seen, equipment 18 may be directly connected to host 12 as illustrated. However, equipment 18 may be connected by a plurality of other way such as to host 12 via network 14 or another network, to computer 20 and/or computer 20 directly or via network 14 and or another network, and/or a combination of these possibilities.

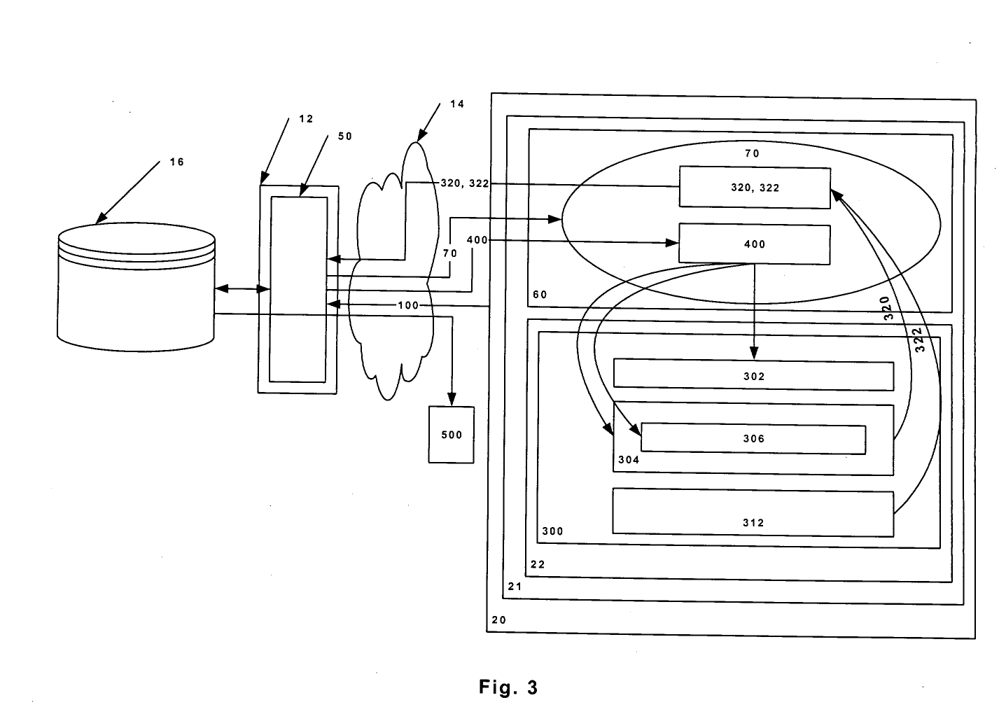

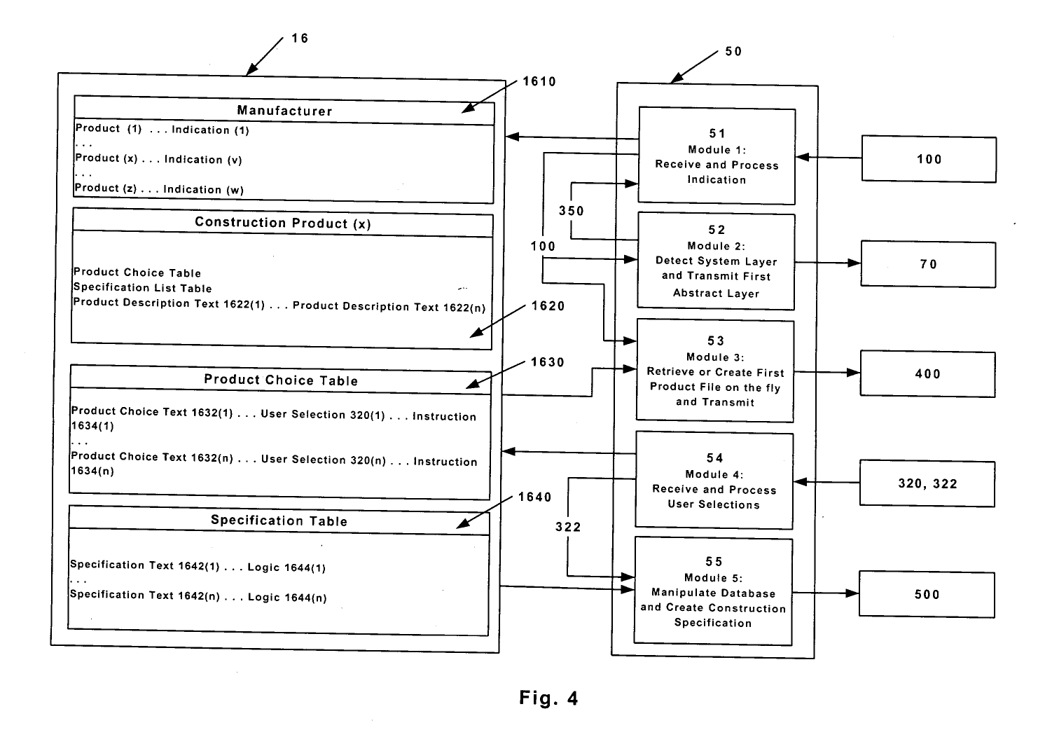

FIG. 3. is a schematic of the interaction between host 12 and computer 20 in accordance with one embodiment of the invention. FIG. 4 is a schematic of the interaction between host 12 and database 16 in accordance with one embodiment of the invention. Executing on host 12 is a plurality of functional software modules 50 which, as may be readily understood, may be combined into one module, less modules than depicted and/or described, and/or more modules than depicted and/or described.

A user, most likely but necessarily a professional in the construction industry, such as an architect, engineer, or specifications writer, typically visits manufacturers' web sites or web sites that offer professional services and products to research and/or select construction products. Therein, the user may encounter a link that enables the user to a create a product construction specification file 500. By clicking the link and accepting the offer, system 10 is initiated and the user herein begins a session. Thus, computer 20 creates an indication 100 associated in database 16 to a manufacturer or to a construction product that host 12 receives via network 14.

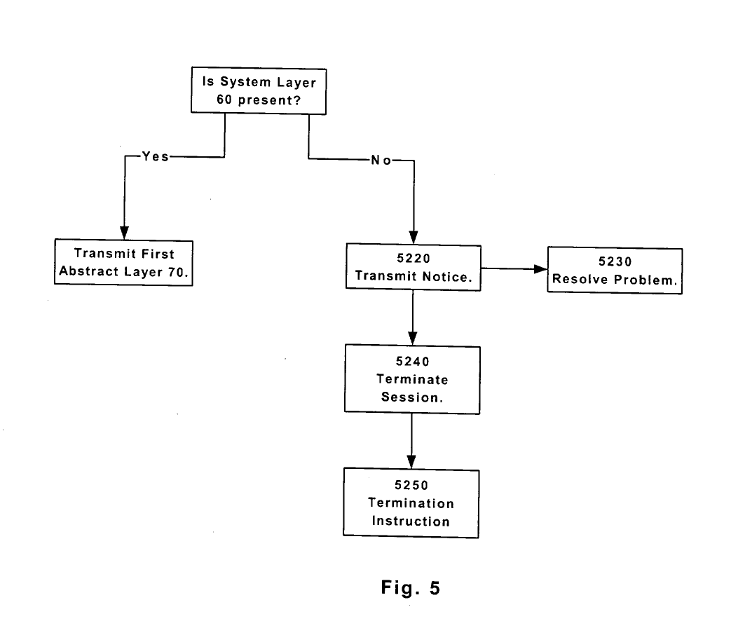

FIG. 5 is a flow diagram depicting the use of functional software module 52 in accordance with one embodiment of the invention. In accordance with one embodiment of the invention, processing module 51 first instructs a functional software module, transmitting module 52, to issue query 5210 to computer 20 to detect if an abstract layer, herein system layer 60, is present. System layer 60 may be any kind of abstract computing layer operating cooperatively on top of an operating system and/or within an operating system to execute one or more instructions. System layer 60 may be implemented as a virtual machine, although not limited to such an embodiment. For example, system layer 60 may be a Chai Virtual Machine developed by Hewlett Packard Corp., a Java Virtual Machine developed by Sun Microsystem Inc., Kaffe Virtual Machine developed under the auspices by kaffe.org, Microsoft Virtual Machine developed by Microsoft Inc., and/or any other virtual machine or abstract layer now known or to be developed.

If system layer 60 is not detect, the user may be duly informed using notice 5220 communicated to computer 20 informing the user that the requisite request cannot be fulfilled. Instead or in addition, other steps may be taken; for example, to aid the user in resolving the problem, predetermined step or steps 5230 may be taken. Such steps may include providing error detection and error correction information, providing links to download and/or import programs and/or plug-ins, scripts to change settings, and/or any other aid. Failing these efforts or absent attempts to resolve the problem, the session is terminated by termination 5240 and termination instruction 5250 is communicated to module 51.

If system layer 60 is detected, the session continues. A first abstract layer 70 for generating a query environment 300 for display to the user on display 22 is forwarded by functional software module 52 to computer 20. First abstract layer 70 comprises an abstract layer for executing one or more instructions cooperatively with system layer 60. To cooperate with system layer 60 when system layer 60 is implemented as a virtual machine, first abstract layer 70 may also be implemented as a virtual machine. However, first abstract layer 70 is not necessarily limited to implementation as a virtual machine even when abstract layer 60 is implemented as a virtual machine. Therein, layer 70 may be any kind of system that executes a series of instructions to generate an environment 300.

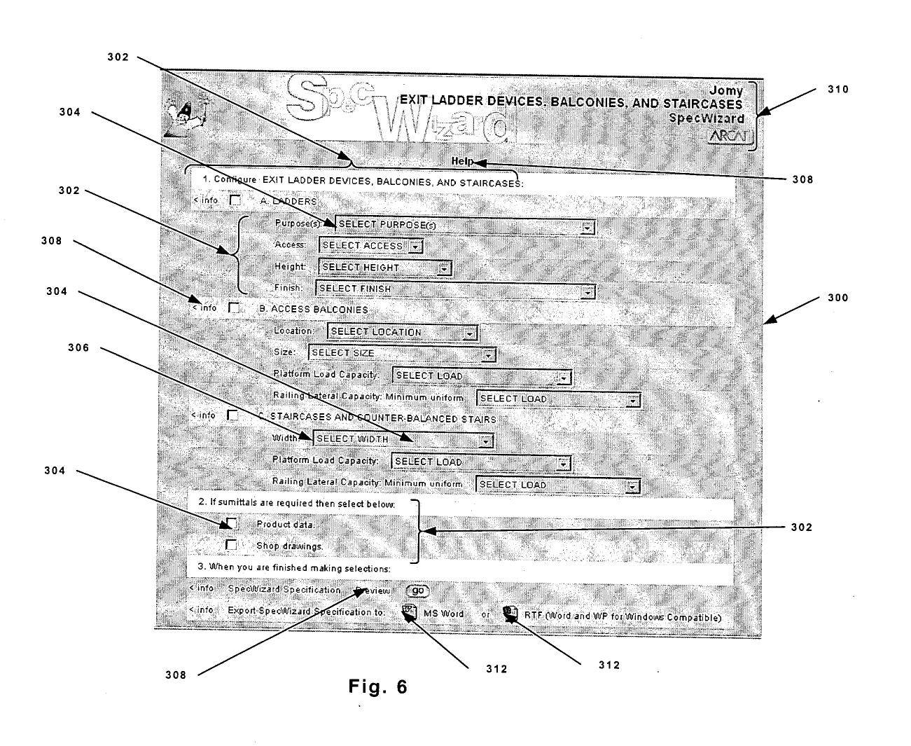

FIG. 6 is a depiction of the query environment 300 in accordance with one embodiment of the invention. Query environment 300 appears on display 22 of computer 20 and is populated a plurality of elements, herein collectively or singularly features 301, associated with indication 100.

Some features 301 are interactive to allow user 30 to make choices and have those choices interpreted as user selections 320. Other features 301 are non-interactive and are intended to provide textual information and/or design elements for environment 300. Thus, features 301 of query environment 300 may include any type of element useful, necessary, and/or desired.

In accordance with one embodiment of the invention, features 301 include a description 302 to display a product name and/or instructions to a user, an interactive menu 304, and a product choice 306 for populating interactive menu 304 with at least one product choice text 1632 and one user selection 320 such that when a user selects a product choice 306, interactive menu 304 generates a user selection 320. Interactive menu 304 may be configured to be any type of interface and/or menu; though menu types that users are generally familiar including a drop down menu, a check box, a slider, a radio dial, and/or a button are preferred.

Environment 300 also may include one or more references 308 that may be a hyperlink that opens or accesses a help web page, executes other function, provides cross-promotions, or provides ways to access a log and/or leave commentaries. Environment 300 may include promotional descriptions and/or banners such as promotion 310 that may provide the manufacturer's name and/or product listings. Promotion 310 may also include images and/or designs.

In accordance with one embodiment of the invention, features 301 include at least one format choices 312 associated with a formatting selection 322 for allowing a user to select the file format of construction specification file 500. Therein, format choices 312 may be word processing formats such as Microsoft Word (.doc and successive version), WordPerfect (.wpd and successive versions), Rich Text File format (.rtf), ASCII text (.txt), Clarisworks, Appleworks, and the like. Other format choices 312 may be associated with Adobe Acrobat portable document format (.pdf and successive formats), scanned file formats (.tiff, .bmp, .jpg and/or .jpeg and successive formats).

To advantageously generate query environment 300, first abstract layer 70 comprises a plurality of data sets capable of generating features 301. To populate query environment 300, first abstract layer 70 executes a first product file 400 comprising at a functional level at least one instruction and at least one product choice.

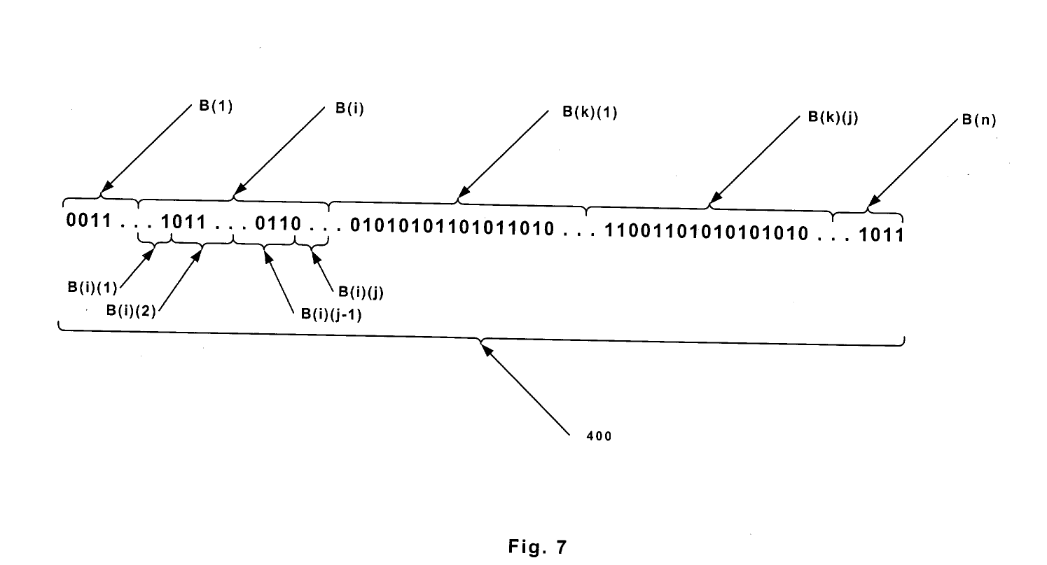

FIG. 7 is a depiction of the binary code of a first product file 400 for populating the query environment 300 in accordance with one embodiment of the invention. As will be readily understood, file structures other than that described herein are possible and are contemplated in the present invention. As will also be readily understood, methods other than that described herein of supplying the data of file 400 are also possible and are contemplated in the present invention. Thus, in accordance with one embodiment of the invention, the data transmitted as first product file 400 may be streamed; packeted; and/or contain encryption keys before, after, and/or intermittent to other data blocks.

First product file 400 comprises a plurality of data blocks B(1) through B(n). Herein and in the figures, “n”, “k”, “m” and “j” are variables for illustrative purposes representing real numbers such that n≧k≧1 and m≧j≧1 and are variable in value from one element being described to the next in the present invention. Variables “i” and “p” represent a real numbers such that n≧k≧i≧1 and ∞≧p≧1. Each data block is comprised of a binary data represented herein for illustrative purposes as randomly selected 0's and 1's. Data block B(1) is an attribute that indicates the beginning of the file and data block B(n) is an attribute that indicates the end of the file.

An instruction data block B(i) comprising data bits B(i)(1) through B(i)(p) of any length is provided. Data bits B(i)(1) through B(i)(p) are one or more executable instruction sets that when executed by first abstract layer 70 populate environment 300 with features 301. For example, one data bit or a series of data bits may instruct layer 70 to create a particular type of an interface 304 and place it relative to another feature 301 and/or relative to the geometry of environment 300.

To populate the interface 304, a further data bit or series of data bits may instruct the first abstract layer 70 to populate interface 304 with product choices 306 transmitted as data blocks, for example data blocks B(k)(1) through B(k)(p). Associated with each product choice 306 may be a further data block or blocks B(k) or data bit or bits B(i)(p) comprising user selection 320.

In accordance with one embodiment of the invention, first product file 400 also includes instructions to display graphics, images, and the like.

Returning to FIG. 4, a functional software module, encoding module 53, assembles a first product file 400 responsive to indication 100 that is forwarded by processing module 51. Therein, module 53 accesses database 16 where a first table, manufacturer table 1610, associates the manufacturer to one or more of its products and associates each construction product to one or more indications 100. A second table, construction product table 1620, associates the construction product to product choice table 1630 and the specifications table 1640. Construction product table 1620 may further comprise one or more product description texts 1622 for presenting product description 302. Product choice table 1630 comprises one or more product choice texts 1632 for presenting one or more product choices 306 in at least one interactive menu 304. Each product choice text 1632 is associated with a user selection 320 and an instruction 1634 for associating the product choice texts 1632 with each other. For example, two or more product choices 306 may be displayed in a predetermined order in the same interactive menu 304 according to instructions 1634.

In accordance with one embodiment of the invention, after querying database 16, encoding module 53 processes product choice texts 1632, user selection 320, instruction 1634, and product description text 1622 into data blocks of first product file 400 according to the predetermined file structure.

Thus, when a user selects a product choice 306 in interactive menu 304 corresponding user selection 320 is forwarded by first abstract layer 70 via network 14 to host 12 to be processed in a functional software module, process module 54. In database 16, specifications table 1640 associates a specifications text 1642 with user selection 320. Specification text 1642 is further associated with a logic 1644 that determines the place specification text 1642 has in construction specification file 500.

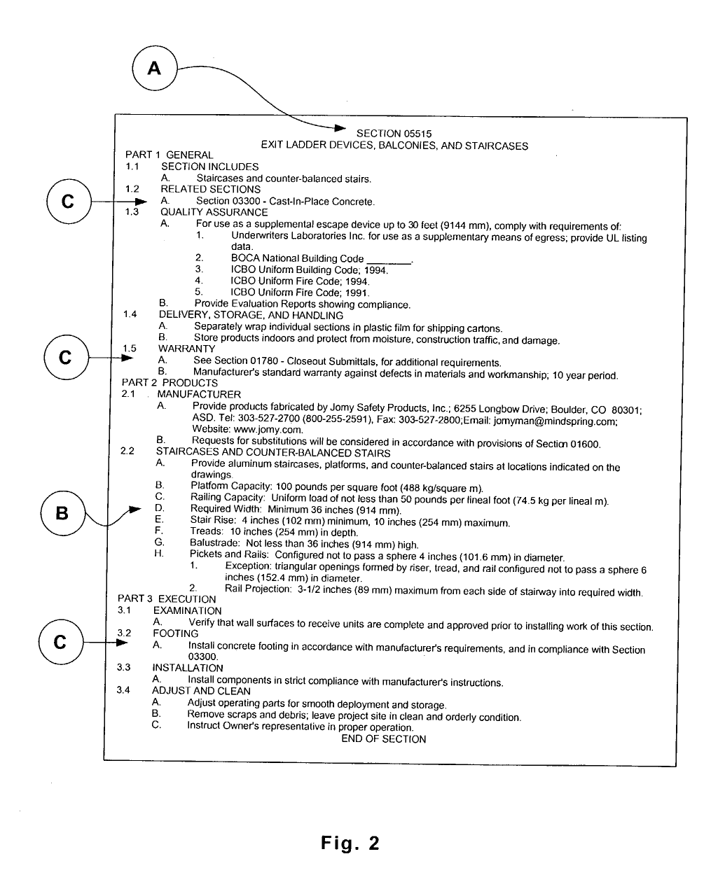

A functional software module, specification assembler 55, receives specification text 1644 and assembles the construction specification file 500 in accordance with the predetermined format. In accordance with one embodiment of the invention, the Construction Specification Institute format shown in FIG. 2 is followed.

In accordance with one embodiment of the invention, assembler 55 receives from module 54 a format selection 322 to correspond to a file format selected by the user. Thereupon, assembler 55 formats the construction specification file 500 in the file format associated with format selection 322.

In accordance with one embodiment of the invention, logic 1644 may be related directly to the text formatting of the specification. For example, each specification text 1642 may be associated with a logic 1644 that includes a plurality of group and/or subgroup recognitions and then an individual identifying attribute. Thus, specification text 1642 associated with a logic 1644 related to a group and/or subgroup recognition are placed into one part of the specification and those with another into another part of the specification.

In accordance with one embodiment of the invention, logic 1644 is predetermined and indirectly related to the text formatting. For example, specification text 1642 is assigned numerical numbers and sequenced numerically in the specification, i.e. numbers are assigned to each text and the text is placed by module 55 in sequential order.

In accordance with one embodiment of the invention, host 12 includes one or more software modules to perform data mining. Therein, a software module is provided that records statistical data during a plurality of sessions. Such data collection may be collecting the IP addresses or network addresses of computers 20, the length of time, the pages and or files accessed, and other identifiable data. Therein, the collected data may be used to promote a manufacturer's products through internet or other marketing. In accordance with one embodiment of the invention, data mining software modules are real time linked

In accordance with one embodiment of the invention, assembler 55 includes the ability to append one or more construction specification files 500 to one or more construction specification files 500 for producing a file 500 that has a construction specification for more than one construction product.

In accordance with one embodiment of the invention, host 12 includes one or more software modules to order the construction product.

In accordance with one embodiment of the invention, equipment 18 is a printing and/or plotting device operatively in communication with host 12 that prepares the construction specifications files 500 in a tangible form, such as for example a service that prepares all specifications in a bid document and or plots them on construction plans.

In accordance with one embodiment of the invention, equipment 18 is a CD-ROM or DVD media drive operatively in communication with host 12 that provides construction specifications files 500 and/or plans on a tangible media.

In accordance with one embodiment of the invention, equipment 18 is a data storage system operatively in communication with host 12 capable of saving and/or modifying construction specifications files 500 in a remote location for access, retrieval, and/or modification by users and/or persons authorized by the user.

What is claimed is:

1. A system for generating a construction specifications file from a predetermined list of construction specifications, the system responsive to a user selection comprising:
a host operatively in communication with a computer;
a database manipulated by the host, the database comprising at least one construction product file associated with a construction product, a user selection, an indication, a product choice, a first product file, and a list of construction specifications;
an indication specific to the construction product, the indication generated by the computer and received by the host;
a first abstract layer for generating a query environment responsive to at least one instruction data block, the first abstract layer executing cooperatively with a second abstract layer on the computer;
a first product file for populating the query environment, the first product file including at least one instruction data block and at least one second data block, the instruction data block executable in the first abstract layer for generating at least one interactive menu in the query environment, the second data block executable in the first abstract layer for presenting the construction product choice in the interactive menu;
a user selection associated with the construction product choice, the user selection generated by the interactive menu upon input by a user, the user selection received by the host; and
a construction specifications file generated by the host by manipulating the list of construction specifications responsive to the user selection.

2. The system of claim 1 wherein the interactive menu is selected from the group of drop downs, dialogs, radio buttons, check boxes, dials, and sliders.

3. The system of claim 1 wherein the first product file further includes a third block, the third data block executable in the first abstract layer for generating at least one format choice, a format selection associated with the format choice associated, the format selection generated by the format choice upon input by the user, the format selection received by the host, the construction specifications file responsive to the format selection.

4. The system of claim 1 further comprising a printer operatively in communication with the host for printing the construction specifications file.

5. The system of claim 1 further comprising a data storage system operatively in communication with the host for accessing, retrieving, and modifying the construction specification file.

6. The system of claim 1 further comprising a media drive operatively in communication with the host for saving the construction specifications file to a corresponding media.

7. A method of generating a construction specifications file from a predetermined list of construction specifications by a host responsive to a user selection, the host operatively in communication with a computer used by a user; the host manipulating a database, the database comprising at least one construction product file associated with a construction product, a user selection, an indication, a product choice, a first product file, and a list of construction specifications; the method comprising the steps of:
receiving an indication generated by a computer specific to a construction product choice;
transmitting a first abstract layer for generating a query environment responsive to at least one instruction data block, the first abstract layer executing cooperatively with a second abstract layer on the computer;
transmitting a first product file for populating the query environment, the first product file including at least one instruction data block and at least one second data block, the instruction data block executable in the abstract layer for generating at least one interactive menu in the query environment, the second data block executable in the abstract layer for presenting the construction product choice in the interactive menu;
receiving a user selection associated with the construction product choice, the user selection generated by the interactive menu upon input by a user, the user selection received by the host; and
generating a construction specifications file by manipulating the list of construction specifications responsive to the user selection.

8. The method of claim 7 wherein the environment further includes a format selection generated upon input by a user, the abstract layer responsive to the format selection, and comprising the further steps of receiving the format selection and formatting the construction specification file in a format responsive to the format selection.

9. The method of claim 7 comprising the further step of appending the construction specification to an existing file.

10. The method of claim 7 comprising the further step of printing the construction specification on a printer operatively in communication with the host.

11. The method of claim 7 comprising the further step of saving the construction specification in a data storage system operatively in communication with the host.

12. The method of claim 7 comprising the further step of saving the construction specification to a media on a media drive operatively in communication with the host.

13. The method of claim 7 comprising the further step of storing statistical data on system access.

14. A method promoting a product using construction specifications comprising the steps of:
providing a host operatively communicating with a computer engaged by a user;
providing a construction product list, the product list including a construction product;
receiving an indication generated by the computer specific to the construction product;
generating an environment in an abstract layer on the computer to display information about the construction product, the abstract layer responsive to a user selection;
receiving the user selection; and
generating a construction specification responsive to the user selection.

15. The method of claim 14 comprising the further step of printing the construction specification on a printer operatively in communication with the host.

16. The method of claim 14 comprising the further step of saving the construction specification in a data storage system operatively in communication with the host.

17. The method of claim 14 comprising the further step of saving the construction specification to a media on a media drive operatively in communication with the host.

18. A file structure of a plurality of data blocks for generating an environment for presenting a construction specification in an abstract layer having a counter and a memory stack, the abstract layer reading the data blocks in sequence, the file structure comprising:
a first and second attribute for signaling the beginning and end of the file;
a first data block readable by the abstract layer for generating at least one interface, the interface displayed in the environment;
a second data block readable by the abstract layer for generating a product description, the product description displayed in the environment; and
a third data block readable by the abstract layer for generating a product choice in the interface.

19. The file structure of claim 24 further comprising:
a fourth data block readable by the abstract layer for generating a format choice.

20. A method of structuring a file, the file comprising a plurality of data blocks for generating an environment for presenting a construction specification in an abstract layer having a counter and a memory stack, the abstract layer reading the data blocks in sequence,
beginning and ending the file with an attribute for signaling the beginning and end of the file;
adding a first data block readable by the abstract layer for generating at least one interface, the interface displayed in the environment;
adding a second data block readable by the abstract layer for generating a product description, the product description displayed in the environment; and
adding a third data block readable by the abstract layer for generating a product choice in the interface.
